(19) United States
(12) Patent Application Publication
(10) Pub. No.: US 2014/0060580 A1
(43) Pub. Date: Mar. 6, 2014

(54) HIGH INTENSITY ULTRASOUND FOR PIPELINE OBSTRUCTION REMEDIATION

(71) Applicants: Thomas O'Donnell, New York, NY (US); Stephen R. Barnes, Bellevue, WA (US); Theodore James Mallinson, Houston, TX (US)

(72) Inventors: Thomas O'Donnell, New York, NY (US); Stephen R. Barnes, Bellevue, WA (US); Theodore James Mallinson, Houston, TX (US)

(73) Assignee: Siemens Corporation, Iselin, NJ (US)

(21) Appl. No.: 13/400,376

(22) Filed: Aug. 28, 2012

(51) Int. Cl. B08B 9/027

(52) U.S. Cl. 134/18; 134/115 R

(57) ABSTRACT

High intensity ultrasound is used for pipeline obstruction remediation. Ultrasound transducers are positioned around an outside of the pipeline. The transducers transmit acoustic energy into the obstruction. The acoustic energy heats the obstruction at a location spaced away from the walls of the pipeline. As the obstruction heats, an opening may be formed in the obstruction, relieving pressure build-up without releasing the plug.

### BACKGROUND

The present invention relates to pipeline obstruction remediation. Hydrates and waxes accumulate in pipelines, often plugging the pipelines. The plug may cause a pressure build-up, arrival pressure fluctuations, unexpected flow behavior (slugging), or uncontrolled release of the plug material. Any of these events may overload the process and instrumentation systems and lead to a flaring event. In some cases, a rupture or other catastrophic failure of production equipment results.

To assure flow, the accumulation of hydrates and waxes may be alleviated. One approach is to apply heat to the exterior of the pipeline. The outer surface of the obstruction melts first. Once loosened, the remaining plug may be propelled by the pressure built up behind the plug. The plug travels at high speed along the pipeline. This may result in significant damage to the pipeline and associated equipment.

### BRIEF SUMMARY

By way of introduction, the preferred embodiments described below include methods, systems, computer readable media, and instructions for pipeline obstruction remediation with high intensity ultrasound. Ultrasound transducers are positioned around an outside of the pipeline. The transducers transmit acoustic energy into the obstruction. The acoustic energy heats the obstruction at a location spaced away from the walls of the pipeline. As the obstruction heats, an opening may be formed in the obstruction, relieving pressure build-up without releasing the plug.

In a first aspect, a method is provided for high intensity ultrasound in pipeline obstruction remediation. The pipeline is scanned with ultrasound. The obstruction is detected from the scanning. In response to the detecting, acoustic energy is transmitted into the pipeline from a plurality of ultrasound transducers positioned around at least a portion of the pipeline. The transmission of the acoustic energy is directed to a portion of the obstruction away from walls of the pipeline.

In a second aspect, a system is provided for high intensity ultrasound in pipeline obstruction remediation. At least one ablation transducer is operable to transmit high intensity focused ultrasound. At least one detection transducer is operable to transmit acoustic energy for imaging. A transmit beamformer is configured to transmit the high intensity focused ultrasound from the at least one ablation transducer. A processor is operable to identify the pipeline obstruction with the detection transducer and to cause the transmit beamformer, with the at least one ablation transducer, to transmit the high intensity focused ultrasound from the at least one ablation transducer and at the obstruction.

In a third aspect, a method is provided for high intensity ultrasound in pipeline obstruction remediation. Acoustic energy is transmitted from a plurality of locations outside of the pipeline. The locations are spaced apart around part of a periphery of the pipeline. A portion of the obstruction is heated with the acoustic energy more than heating of the obstruction adjacent to the pipeline with the acoustic energy. The acoustic energy travels from different directions to constructively combine at the portion with less combination adjacent to the pipeline.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for high intensity ultrasound in pipeline obstruction remediation;

FIG. 2 is a perspective view of a cuff transducer arrangement for ultrasound imaging and high intensity focused ultrasound remediation according to one embodiment;

FIG. 3 is a cross-sectional view of an example of a pipeline and a cuff of transducers; and

FIG. 4 is a flow chart diagram of one embodiment of a method for high intensity ultrasound in pipeline obstruction remediation.

### DETAILED DESCRIPTION OF THE DRAWINGS AND PRESENTLY PREFERRED EMBODIMENTS

An obstruction in a pipeline is detected through ultrasound imaging, as well as remediated through high intensity ultrasound ablation. In one embodiment, a bandolier of ultrasound transducers surrounds the pipe. These transducers provide a visual confirmation of the obstruction by performing tomography to reconstruct the morphology of the plug and/or measure the flow through the pipe via Doppler ultrasound. Once detected, a conformal approach may be employed for ablation. The ultrasound transducers focus high intensity energy on the same point in the interior of the pipe, warming the plug while sparing the surrounding regions from the same degree of exposure. Cavitations and/or displacement caused by the acoustic energy may be used instead of or in addition to heating. The interior portions of the plug melt first, increasing the flow and decreasing pent up pressure. The entire plug may dissipate and equipment downstream spared.

Through locating an obstruction using a non-invasive ultrasound, the operational disruption of an inspection pig operation may be avoided. In the case of hydrate and paraffin plug/accretion removal, use of the high intensity focused is a gentle approach which reincorporates the blockage material progressively into the flow stream, rather than the abrupt release of material.

Oil, gas, or other fluids or gases are transported by flow through a pipeline. The pipeline may be made of steel, ductile iron, or other metal. The exterior of the pipeline may be coated in insulation material. Any size pipeline may be used, such as eight inch to three foot inner or outer diameters. Pipelines are used on land, underwater (e.g., subsea), in cold climates, in hot climates, and in temperate climates. For example, the pipeline is deployed in a high pressure, deep sea environment. The pipeline may include joints, turns or bends, valves, or other structures.

A plug may form at various locations along the pipeline. Plugs may repetitively form at a same location due to local conditions. Plugs are formed of gradual deposits of paraffin (e.g., wax), asphalt, methane hydrate, or other materials. The build of these materials may partially or complete obstruct the pipeline.

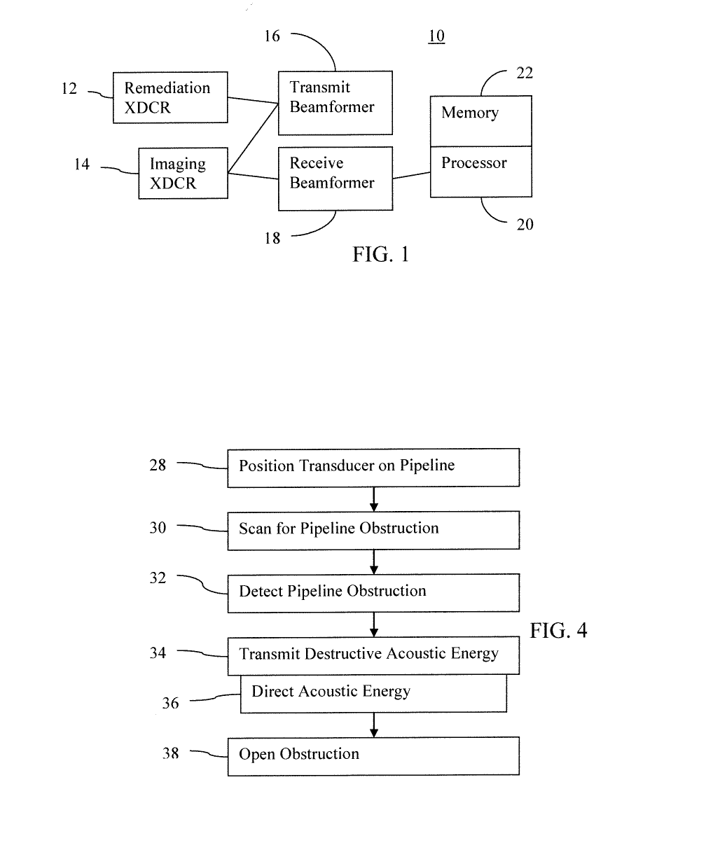

FIG. 1 shows a system 10 for high intensity ultrasound in pipeline obstruction remediation. The system 10 includes an ablation transducer 12, a detection transducer 14, a transmit beamformer 16, a receive beamformer 18, a processor 20, and a memory 22. Additional, different, or fewer components may be used. For example, the ablation and detection transducers 12, 14 may be a same device. As another example, more transducers of either type may be provided. In another example, a display is provided. Different transmit beamformers 16 may be used for the different types of transducers 12, 14. In yet another example for remediation relying on other types of detection, the receive beamformer 18 and detection transducers 14 are not provided.

In one embodiment, the system 10 is part of a fixed installation. The system 10 is positioned, at least partly, around a pipeline at one location. Using straps, bolts, glue, clamps, or other connector, the system is fit to, held around, or connected with the pipeline. In another embodiment, the system 10 releasably connects with the pipeline or is part of a robot for moving along the pipeline. The system may be pulled along the pipeline manually.

The components of the system 10 are in a same housing. For an undersea or other deployment, a cable for communications and power is provided to the components of the system 10. Rather than transmitting beamforming or other ultrasound data path signals, control signals and power are transmitted over a long cable or wirelessly. An image may be transmitted. Alternatively or additionally, a binary signal indicating detection of an obstruction or not is transmitted. In one example deployment, a boat or rig with a power source permanently or releasably connects with a cable supported by a buoy for operating the system 10. In alternative embodiments, one or more components are in a separate housing. For example, the processor 20 and memory 22 are with the power source and connect to the beamformers 16, 18 and transducers 12, 14 through a cable.

The ablation transducer 12 is any now known or later developed transducer for generating high intensity ultrasound from electrical energy. A single element may be provided. The single element may have a focus due to shape or a lens or may be unfocused. A plurality of elements in a one or multi-dimensional array may be used, such as an array of N×M elements where both N and M are greater than one for electric based focusing or steering.

The element or elements are piezoelectric, microelectromechanical, or other transducer for converting electrical energy to acoustic energy. For example, the ablation transducer 12 is a capacitive membrane ultrasound transducer.

The ablation transducer 12 is operable from outside the pipeline. For example, the ablation transducer 12 is a probe or other device held against the exterior of the pipeline or surrounding insulation. The emitting surface of the ablation transducer 12 is curved to fit on the pipeline. Different amounts of curvature are used for different pipeline sizes. Alternatively, a matching block or other piece fits between the ablation transducer 12 and the pipeline. In one embodiment, pipe insulation is applied over the ablation transducer 12 so that the ablation transducer contacts the pipeline or a matching layer substance on the pipeline. The ablation transducer 12 is handheld, positioned by a device, strapped or otherwise placed into contact with the pipeline. In other embodiments, the ablation transducer 12 is in a pig, probe, or other device for operation from within the pipeline.

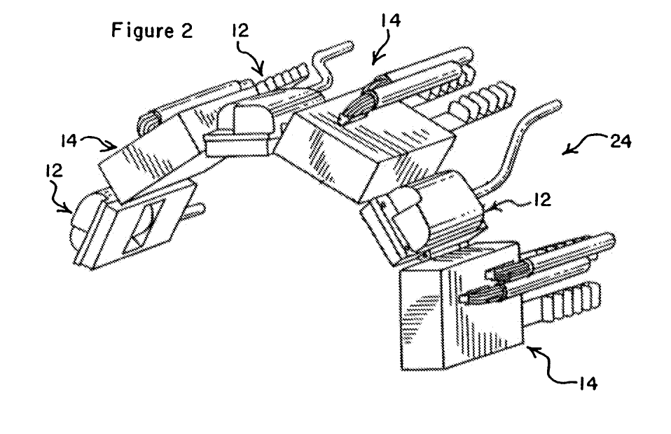

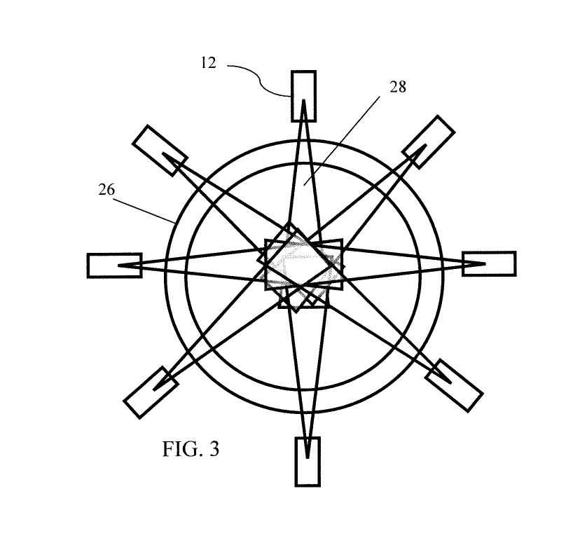

In one embodiment, only one ablation transducer 12 is provided. In other embodiments, a plurality of ablation transducers 12 is provided. For example, a plurality of two-dimensional arrays of elements is used for transmitting from different locations to an ablation or remediation region. FIGS. 2 and 3 show use with a plurality of ablation transducers 12.

The detection transducer 14 is the same or different type, material, size, shape, and structure than the ablation transducer 12. For example, one or more detection transducers 14 each include a multi-dimensional array of capacitive membrane ultrasound transducer elements. The detection transducer 14 is any now known or later developed transducer for diagnostic ultrasound imaging or detection. The detection transducer 14 is operable to transmit and receive acoustic energy.

Where the detection and ablation transducers 12 14 are different devices, the spatial relationship between the transducers 12, 14 is measurable. For example, pairs of the detection and ablation transducers 12, 14 are fixedly connected together or a sensor measures the relative motion between the two. Any sensor may be used, such as magnetic position sensors, strain gauges, fiber optics, or other sensor. Alternatively or additionally, acoustic response from the arrays indicates the relative positions. Correlation of imaging data may indicate spatial relationship between detection transducers 14. In other embodiments, the same array or arrays are used for both remediation and imaging.

In one embodiment, the remediation and detection transducers 12, 14 are in a cuff 24. The cuff 24 is plastic, metal, fiberglass, or other material for rigidly, semi-rigidly or flexibly holding the plurality of transducers 12, 14 with or without the beamformers 16, 18, and/or processor 20. For example, FIG. 2 shows a cuff 24 with a plurality of transducers 12, 14. Hinges, other structure, or an outer casing interconnect the transducers 12, 14. One or more sets of transducers may be more rigidly connected.

The cuff 24 includes every other transducer as a detection transducer 14 and an ablation transducer 12. Other ratios and/or arrangements may be provided. One, more, or all of the transducers may be dual use devices, such as each transducer 12, 14 being for detection and ablation. In one embodiment, each of the detection transducers 14 is operable to electronically or electronically and mechanically scan in three dimensions for acquiring data representing a volume. The transducers 14 may be arranged such that, at least for deeper depths within the pipeline, the scan volumes of adjacent detection transducers 14 overlap. In alternative embodiments, the detection transducers 14 scan along a plane or line. The detection transducer(s) 14 may be used to merely detect the presence or not of an obstruction, so may have no or a fixed focus and scan only in one direction.

A covering, such as a fabric, plastic or other material, may relatively connect the transducers 12, 14. A housing encapsulates the cuff 24, waterproofing the system 10. For example, the transducers 12, 14, transmit beamformers 16, 18, processor 20, and memory 22 are enclosed within the covering. The cuff 24 is a band or other structure for wrapping around, connecting to, or resting on the pipeline. FIG. 2 shows the cuff 24 of transducers 12, 14 wrapped at least partially around a pipeline with some internal flow region represented. The ultrasound devices are embedded in a flexible surface, wrapped around the pipeline. This geometry may allow acquiring 360-degree images around an obstruction with a single array.

In one embodiment, the transducers 12, 14 are distributed in a blanket type arrangement or multi-dimensionally. FIG. 2 shows the transducers 12, 14 in a linear arrangement wrapped at least partially around the pipeline. FIG. 3 shows the transducers 12, 14 wrapped entirely around the pipeline 26. Additional of these arrangements may be placed adjacent to each other in the same or different cover to blanket the pipeline so that multiple transducers 12, 14 are provided along a length direction of the pipeline.

The cuff 24 connects to or around the pipeline. For example, magnets connect the cuff 24 to the pipeline. As another example, a strap or pipe clamp holds the cuff 24 to the pipeline. Glue or other fasteners may be used.

The cuff 24 adapts to the pipe orientation. By wrapping the cuff 24 at least partly around the pipeline, the flexible or hinged portions of the cuff 24 adapt the cuff 24 to the pipe. One size cuff 24 may be used on different sized pipes or cuffs 24 for particular sizes of pipes are used. The width of the cuff 24 (i.e., distance along the length of the pipe) is sized as appropriate for the plug, pipeline, or comprehensive remediation approach.

The transmit beamformer 16 has a plurality of waveform generators, pulsers, amplifiers, delays, phase rotators, and/or other components. For example, the transmit beamformer 16 is waveform generators for generating square or sinusoidal waves in each of a plurality of channels. The waveform generators or downstream amplifiers set the amplitude of the electrical waveforms. For detection, the amplitude is set to provide scanning with one or more acoustic beams. The amplitude may be set for the same for scanning to detect and for high intensity ultrasound to ablate. Alternatively, the scanning for detection uses a lower amplitude to limit reverberation associated with sound reflections within the pipe.

Relative delays and/or phasing of the waveforms focus the transmitted acoustic energy. By applying relatively delayed and/or apodized waveforms to different elements of a transducer, a beam of acoustic energy may be formed with one or more foci along a scan line. Multiple beams may be formed at a same time. For electronic steering, the relative delays establish the scan line position and angle relative to the transducer 12, 14. The origin of the scan line on the transducer 12, 14 is fixed or may be adjusted by electronic steering. For example, the origin may be positioned on different locations on a multi-dimensional array. The different origins result in different positions of the respective scan lines.

In an alternative embodiment, fixed focus or no focus is provided. The element or elements of the transducer generate a wavefront without steering by the beamformer 16. The detection transducers 14 may use electronic steering, and the ablation transducers 12 may not, or vice versa. The transmit beamformer 16 may generate electrical waveforms for generating acoustic energy, whether steered or not.

For ablation or remediation, relatively delayed electrical signals are generated by the transmit beamformer 16 for focusing the high intensity focused ultrasound at a portion of the pipeline obstruction spaced from walls of the pipeline. FIG. 3 shows the beams 26 from multiple transducers 12 focused at the center. The portion may be determined from a known size of the pipe. The focus is positioned to be at a center or other location of the pipe. Alternatively, the portion is determined from image analysis of an ultrasound imaging of the pipe. In other embodiment, the beams 26 are not focused, but the transducers 12 are pointed so that the acoustic energy from the different beams 26 constructively converges at the center or near the center.

For scanning or detection, focused or unfocused transmissions are generated by the transmit beamformer 16. For example, a fixed or no focus is used to detect response from a given location, such as the center of the pipe. As another example, beams are formed along different scan lines. Any pattern may be used, such as linear, sector, or Vector®. The pattern is for scanning a plane. A volume may be scanned by a scan format for the volume or by scanning multiple planes.

The receive beamformer 18 receives electrical signals from the detection transducer 14. The electrical signals are from different elements transducing from acoustic echoes from the transmission. Using delay and sum beamforming, fast Fourier transform processing, or another process, data representing different spatial locations in a volume is formed. One, a few, or many transmission and reception events may be used to scan a volume with the detection transducer 14. For example, plane wave transmission and reception is used for scanning a volume. Multiple beam reception with or without synthetic beam interpolation speeds volume scanning with delay and sum beamformation. In alternative embodiments, a two-dimensional plane or scan lines are scanned instead of a three-dimensional volume. In yet another alternative embodiment, the receive beamformer 18 samples along a single line or for a single location, such as associated with measuring flow at a center of the pipeline.

The beamformed data is detected. For example, B-mode detection is provided. In another example, Doppler power, velocity, and/or variance are detected. Any now known or later developed detection may be used. The detected data may be processed to determine volume flow, pressure, or other information, such as by processing combinations of different types of detected data (e.g., B-mode to determine area of flow and Doppler velocity to determine rate of flow for deriving volume flow). The detected data may be scan converted, remain formatted in the scan format (e.g., polar coordinate), interpolated to a three-dimensional grid, combinations thereof, or converted to another format. In another embodiment, the detection represents a single point or imaging is not being provided, so scan conversion is not provided. The detection and/or format conversion are done by separate devices, but may be implemented by the processor 20.

The processor 20 is a general processor, central processing unit, control processor, graphics processor, digital signal processor, three-dimensional rendering processor, image processor, application specific integrated circuit, field programmable gate array, digital circuit, analog circuit, combinations thereof, or other now known or later developed device for detection of an obstruction and/or controlling application of high intensity ultrasound in remediation. The processor 26 is a single device or multiple devices operating in serial, parallel, or separately. The processor 26 may be a main processor of a computer, such as a laptop or desktop computer, or may be a processor for handling some tasks in a larger system, such as in an imaging system. The processor 26 is configured by hardware and/or software.

The processor 20 identifies the pipeline obstruction with the detection transducer 14. One or more detection transducers 14 are used by the beamformers 16, 18 under the control of the processor 20. The processor 20 identifies any obstruction from the beamformed data. The data representing a point, line, plane, or volume may be processed to identify the obstruction. The speckle characteristic from B-mode data may indicate the type of material (e.g., oil verses wax). The shape or arrangement may indicate an obstruction, such as showing a channel or other region different than elsewhere within the pipe (i.e., other than smooth cylinder). The amount of flow may indicate an obstruction. If no or unusually rapid or turbulent (variance) flow is detected, an obstruction may be indentified.

The obstruction is identified as being generally within the pipe. Alternatively, the location of the obstruction along a length of the pipe is identified. For example, the scan may include regions of the pipe directly next to or between the transducers 14, next to or between one and not others of spaced apart detection transducers 14, or upstream or downstream of the detection transducers 14.

The processor 20 causes the transmit beamformer 16, with at least one ablation transducer 16, to transmit the high intensity ultrasound from the ablation transducer(s) 16 and at the obstruction. The processor 20 may control the focus of the generated beams 26. A sequence, repetition rate, duration, focal scan pattern, amplitude, frequency or other characteristic of the beams 26 may be controlled. For example, different beams 26 are used for different types of plugs or size of plugs or different size of pipes (e.g., more power for larger pipes and associated plugs). As another example, the beams 26 vary based on the amount of flow created or not. In another embodiment, the processor 20 merely controls whether the transmit beams 26 are turned on or not. The beams 26 are fixed (i.e., same frequency, focus, and/or amplitude) and the processor 20 turns on these fixed beams 26 when an obstruction is detected.

The processor 20 controls the transmission for all of the ablation transducers 12. The ablation transducers 12 may be operated the same, such as having a same frequency, amplitude, and/or focus relative to the transducers 12. The transmit beamformer 16 may be controlled to provide for different foci for the different transducers 12, such as for directing the beams all to a same location within the pipe (i.e., different transducers 12 steer differently to project the beam to the same location). The beams 26 may be directed to different locations, such as having some beams 26 directed to an upstream location on the plug at a center of the pipe and others to a downstream location on the plug at the center of the pipe. The processor 20 may control the transmit beamformer 16 to cause the beams to be formed along particular paths or with different characteristics. Air pockets or regions of greater density in the plug may be identified. The beams may be formed to avoid intersecting these regions.

The processor 20, based on interleaved or later performed scanning for detection, may determine an amount of remediation of the obstruction. An amount of flow, velocity of flow, area of opened channel or other characteristic of remediation may be detected. By heating the plug with the high intensity ultrasound, a channel may be opened and flow increased or started. The processor 20 may monitor progress in order to steer further transmissions, cease remediation, and/or report.

The memory 22 stores the ultrasound data for detection processing. Alternatively or additionally, the memory 22 stores instructions for programming the processor 20 for obstruction remediation. The instructions for implementing the processes, methods and/or techniques discussed above are provided on non-transitory computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

The system 10 may include a power source. The power source may be local to the beamformers 16, 18, such as storage capacitors, battery, water flow-based generator, or engine. In one embodiment, the power source is remote, such as being on a boat or rig for undersea pipelines. A small turbine or other source for outputting kilowatts of power instantaneously or over time may be used.

FIG. 4 shows a method for high intensity ultrasound in pipeline obstruction remediation. The method uses the system 10 of FIG. 1, the cuff 24 of FIG. 2, the arrangement of FIG. 3, different transducers, different arrangements, and/or different systems. The acts are performed in the order shown or a different order. Additional, different, or fewer acts may be used. For example, the method is performed without act 28, act 30, and/or act 32. The detection may be provided separately or the existence of the plug assumed. For example, a pressure build-up may be detected in the pipeline. Acoustic energy to remediate plugs is activated at one or more selected locations along a length of the pipeline. In the case of assuming there is a plug, the fluid and pipeline itself may dissipate the heat without harm if no plug is at a given location.

In act 28, the ultrasound transducers are positioned on the pipe. A person may position the transducers, such as wrapping a cuff or blanket around the pipe. The cuff or blanket may be tightened or strapped to the pipe. A robot may position the ultrasound transducers, such as a submersible robot placing the transducers on the pipe. Using clamping, bonding, magnetism, gravity, or other connection, the transducers are placed on the pipe.

Prior to positioning on the pipe, a mating material may be placed on the pipe or transducers. For example, ice is formed on the pipe. As another example, an acrylic or mercury is deposited on the pipe or transducers. The mating material has an acoustic impedance between the acoustic impedance of the transducers and the pipe. Layers of different material may be used, such as to provide a more gradual transition of acoustic impedance. These matching layers may avoid more sudden transitions in acoustic impedance, allowing transmission of more acoustic energy into the pipe.

The transducers are spaced around a portion of the pipe. For example, the transducers are spaced around at least 120, 150, or 180 degrees of the circumference of the pipe. The transducers may be spaced around the entire circumference of the pipe. The transducers may have no or some spacing between each transducer. FIG. 2 shows transducers with little spacing, but with ablation transducers spaced apart by detection transducers. FIG. 3 shows the ablation transducers spaced apart, with or without any intervening transducers. Alternatively, a single transducer (e.g., element or array) is positioned at one location on the pipe.

The transducers may also be spaced along a length of the pipe, such as positioning a multi-dimensional array of transducers where each transducer is a single element, one-dimensional array of elements, or multi-dimensional array of elements. Any spacing may be used between transducers along the length of the pipeline. Any pattern of distribution of the transducers along and around the pipeline may be used.

In act 30, the pipeline is scanned with ultrasound. The scanning may be merely transmitting and receiving at a given location. Alternatively, the scanning is steering transmit and receive beams over a plurality of spaced apart scan lines. Acoustic energy is transmitted along a plurality of scan lines, and echoes are received in response to the transmissions. The received echoes are converted into received electrical signals. The transmission and reception are performed for imaging and/or detecting obstruction. A point, line, plane, or volume is scanned.

One or more transducers are used for detection. The scanning is performed with a single array or transducer or with different transducer arrays of elements. For example, one or more transducers scan the same or different lines or points for detection without combination. In another example, different transducers scan the same region or overlapping regions in the pipe (e.g., scan overlapping or a same cross-section of the entire or central interior of the pipe). The resulting data from the different transducers may be aligned and combined.

Rather than line, point, or plane scanning, a dataset representing a three-dimensional volume may be formed by transmitting and receiving. The dataset is formed by scanning an entire volume. Alternatively, different scans of overlapping volumes are performed, and the overlapping volumes are combined. Different transducers scan different, but overlapping volumes.

In one embodiment, a stitching or “mosaicking” operation combines different volumetric datasets. For example, a first volume is expanded or added to with each new volumetric acquisition, while assuring insertion of the new information at the correct spatial position. In one embodiment, an ultrasound blanket device performs an initial acquisition, taken as reference. Then, additional volumes are sequentially acquired for combination.

The overlapping volumes are aligned. Position sensors, data correlation, or combinations thereof are used to determine the relative spatial position of the overlapping volumes. For correlation, speckle or features may be used. In one embodiment, power Doppler information is segmented to identify one or more surfaces in each data set. The surfaces are then correlated by searching different rotations and/or translations. The relative position with the highest or sufficient correlation indicates the proper alignment. Cross-correlation, minimum sum of absolute differences, or other correlation may be used.

In other embodiments, B-mode data is used for alignment. In another embodiment, the power Doppler-based alignment is refined by further B-mode alignment. The power Doppler provides a lower resolution alignment, and the B-mode provides a higher resolution alignment. Features, speckle, segmentation, or other processes are used for B-mode alignment. For example, B-mode data with or without spatial filtering is correlated without specific feature extraction. In yet another embodiment, position sensor information or known spatial limitations of the relative position of the transducers (e.g., semi-rigid connection between transducers) is used to limit the search space for correlation. Any search technique may be used, such as set searching, numerical optimization, coarse-fine, or other.

The data of the aligned volumes is combined. The information is merged with the previous scan, based on the known mutual location of the transducers or volumes. Any combination may be used, such as selecting a datum for each spatial location from available datasets, averaging, weighted averaging to avoid combination artifacts, or interpolation. The aligned and combined volumes provide a larger three-dimensional volume. The volume dataset may be used for three-dimensional position determination. For example, a cut plane, which intersects and is co-axial with a plug, is formed for identifying a region to be ablated.

The scanning is performed with different transducers than used for remediation. Alternatively, the same transducers are used for both detection and remediation.

In act 32, the obstruction is detected from the scanning. Any detection may be used. For example, flow in the pipeline is measured. Any technique for measuring flow in a pipe may be used. The velocity at one or more locations (e.g., velocity throughout an area of a cross-section) is measured. The power of the flow return or the variance may alternatively or additional be used. The spectrum of flow at one or more locations may be measured, such as using spectral Doppler techniques. A higher than normal velocity may indicate a partial blockage. No or little flow may indicate a complete blockage. The flow may be detected at one location or a plurality of locations.

In another embodiment, morphology of the obstruction is identified. A characteristic of the acoustic return from a plug may be different than from the gas, oil, or other flowing contents of the pipe. Using frequency, amplitude, speckle, or other analysis, the characteristics associated with a plug may be detected. For example, a wall or surface within the pipe may be detected. As there should be no surface other than from a plug, the plug is detected. Data representing a volume may be analyzed to find the continuous surface or surfaces of the plug, such as a front and back wall with or without any flow channels of the plug. The locations of the obstruction are detected.

The obstruction in the pipe is detected with ultrasound transmitting and receiving from outside of the pipe. Alternatively, the obstruction is detected with a pig using ultrasound, optics or other mechanism. In other embodiments, the plug is not detected.

Based on the detection and/or scanning, the portion of the plug or within the pipe to be ablated or removed is identified. The region to be remediated is identified. Manual, automatic, or semi-automatic identification is used. For example, the user selects a point in different views as indicating the location at which a channel is to be formed. The geometric relationship of the different views may provide an indication of a location in a volume. As another example, a processor identifies the region. An image process is performed to identify the shortest channel that may be formed whether at the center or not. The volume dataset or other data representing the plug is processed.

In one embodiment, ultrasound data representing the volume, such as acquired with a blanket ultrasound device, is used to localize a weak point in the plug. For example, a line associated with a shortest distance between upstream and downstream walls of the plug is found. As another example, B-mode data shows material of the plug more likely to respond to high intensity ultrasound. In yet another example, acoustic force radiation is used to vibrate the plug to identify weaknesses, such as more or less rigid regions of the plug.

In an alternative embodiment, a specific region of the plug is not identified. Instead, the portion for remediation is assumed, such as using a center of the pipe along a length regardless of a length of the plug or based on a length of the plug.

Based on the selected region, detected type or material of the plug, size of the plug, diameter of the pipe, thickness of the pipe, type of material of the pipe, temperature, pressure, or other characteristic, the characteristics of the high intensity ultrasound transmit beam or beams are determined by a processor, by a user, or combinations thereof. The characteristics include power, frequency, and/or other characteristics (e.g., duration, sequence, or pulse repetition interval). The determination may be a function of the selected region to be ablated. The determination is a function of the desired ablation or amount of power to be delivered in a specific period to cause destruction, melting, disintegration, or reincorporation. Any now known or later developed dosage considerations may be used.

In one embodiment, the power and frequency of the high intensity ultrasound is determined, at least in part, as a function of a characteristic of the path from the transducer to the location of ablation. For example, the frequency of the high intensity ultrasound adapts as a function of depth from the transducer, attenuation characteristic along the path, or combinations thereof. The optimum frequency depends on the target depth, attenuation constant, the transmit transfer function of the transducer, and any limiting factor, such as the loss of acoustic energy passing through the pipe. Limiting factors may include, for example, maximizing the power absorption at the target depth or minimizing the power absorption at or near the pipe. The frequency at which the acoustic intensity is highest may not be the optimum frequency because of the frequency dependence of the acoustic absorption. A desired or optimum frequency may be calculated given the target depth, pipe thickness, pipe material, and the type of plug material between the target and the transducer. Image processing, thresholding, a predetermined setting, or other technique may be used to distinguish types of material. The different types are associated with different acoustic attenuation.

Heating is achieved by absorption of acoustic power. Acoustic absorption is proportional to an attenuation coefficient. Higher attenuation provides higher acoustic power absorption and heat generation. Attenuation and absorption increase with frequency, so it is desirable to use higher frequencies for heating. However, higher propagation attenuation at higher frequencies means shallower penetration depth. There is a trade-off between penetration depth and frequency, and heat. For a given depth of the treatment region, there may be a better frequency at which maximum power deposition (so ΔT) is achieved.

For a plane wave, the pressure at a depth z is related to the pressure at the surface of the transducer with the following equation:

P(z)=P₀·e^{-α·f}^{^{k}}^{·z},

P(z) is the pressure amplitude as a function of depth (z), P₀ is the pressure at z=0, and α·f^{k} is the frequency dependent tissue attenuation constant (k usually takes a value between 1 and 2 depending on the material). The acoustic power absorbed by the material, L(z), is then calculated as:

$$L ( z ) = \frac{α \cdot {f}^{k}}{{Z}_{0}} {P}^{2} ( z )$$

Absorbed power is proportional to the frequency dependent attenuation constant. The frequency where maximum acoustic power absorption is achieved:

$${f}_{max} = {( \frac{1}{2 \cdot α \cdot z} )}^{\frac{1}{k}}$$

The optimum frequency depends on the depth and attenuation constant. Note that, this calculation is for simple plane waves and is intended to show the dependence of the optimum frequency on the depth and attenuation constant. Ablation beams may be transmitted as a plane wave, with no focus, or with a greater focus. For a transducer with transmit beamforming and a non-uniform material type between the transducer and the target (e.g., non-uniform attenuation constant), the optimum frequency may be calculated numerically.

The absorption depends on the attenuation constant. Knowing an average material attenuation or the material attenuation profile between the target and the transducer may increase the accuracy of optimum frequency calculation. The attenuation constant of different detectable material types may be determined and incorporated into the algorithm.

The operating frequency may be chosen to avoid heating the pipe more than the target region of the plug. Depending on the limiting factor (power absorption at the target depth or power absorption at the pipe), the optimum frequency and/or amplitude may be different. By spacing a plurality of transducers around the pipe, greater heating is likely within the plug than at any point on the pipe.

In addition or as an alternative, the power dose of the high intensity ultrasound from each of the transducers is determined. The power dose may be determined a function of material along the beam path, distance from the transducer to the treatment region along the path, number of paths, frequency of the transmission, combinations thereof, or other factors. For example, different material types provide different attenuation. The different attenuation of the treatment region and the regions between the treatment region and the transducer may alter the power delivered for treatment. Greater attenuation along the path may result in a higher power dose transmitted from the transducer. Greater absorption at the treatment region may result in a less power dose transmitted from the transducer. The reflections of acoustic energy within the pipe may be considered. The power dose is altered by changing frequency, amplitude, or number of cycles of the transmitted waveforms.

The specific material type may be identified. Alternatively, the intensity of the echoes or data along the path may indicate material characteristics. By collecting the intensities along the paths, the amount of power to reach that particular point of ablation with a desired power level is calculated. The average intensity, sum of intensities, or intensity profile may correlate with attenuation. Other functions may be used to determine power dose.

In an alternative embodiment, plug and/or pipe considerations are not calculated. Instead, an assumed or standard power dose is used.

In act 34, acoustic energy is transmitted into the pipeline. The acoustic energy is transmitted as one or more beams focused at a same region at a same time. The beams are focused by corresponding arrays of elements. Using delays and/or apodization, the elements of each array generate acoustic energy that constructively interferes at the focus. Alternatively, the acoustic energy is transmitted without focus but from different directions so that the region of greatest intensity is away from the walls of the pipe. With or without focused beams, the acoustic energy from a plurality of ultrasound transducers positioned around at least a portion of the pipeline contribute to energy at a region of the plug. Alternatively, acoustic energy from a single transducer is used.

The transmission is in response to the detection of the plug. Once the plug is detected, the transmissions begin immediately. The transmissions may instead delay a start until a control signal, such as from a user or timer, is received.

The acoustic energy is transmitted from outside of the pipeline. The transducers are positioned around the pipeline at various locations, such as shown in FIG. 3. The acoustic energy from the locations travels through the pipe walls and into the pipe, such as into the plug. Given the transducer spacing around at least a part of the periphery of the pipe, the beams of acoustic energy converge at a desired region of the plug, such as at a center of the pipe or other region.

The acoustic energy at the convergence has the power to melt or remediate the plug. The transmissions are of a desired power or power profile over time and frequency or frequency profile over time to remove the plug material at the region of convergence. The frequency may be any acoustic frequency, such as greater than 1 MHz or 20-400 kHz. The power dose may take into consideration the reflection of acoustic energy from the pipe walls. Energy propagating into the pipe may bounce off of an opposite wall. For example, reflection at the steel/hydrate interface leads to most of the energy being dissipated in the hydrate. The frequency, amplitude, sequence of transmissions, duration, and pulse repetition interval may be set based on the pipe material, plug material, and any environment factors (e.g., temperature and pressure).

In act 36, the transmissions of the acoustic energy are directed to a portion of the obstruction. The portion is away from walls of the pipeline. By directing the transmissions, a greater intensity of the acoustic energy is provided at the portion than locations spaced away from the portion. The acoustic energy focused from one array, provided from the different arrays, and/or due to reflections from the pipe constructively sums at the portion and less so at the plug near the walls of the pipe.

In one embodiment, the locations of the transducers, with or without focus of the beams, direct the acoustic energy to the center or other location. For example, FIG. 3 shows the beams 36 constructively summing at the center. Similarly, reflections may cause greater intensity at the center or other non-wall location.

In another embodiment, the beams are focused. Using a single transducer or a group of transducers, the beam or beams are directed to the desired location, such as the center of the pipe. The detected location of the plug is used to guide focus of the beams. A weak point or other detected information about the plug may be used to guide the focus of the beams.

The location of the focus or portion being subjected to the greatest or most of the acoustic energy may shift over time. As the plug material is removed, the focus may shift to continue to remove other material. The acoustic energy is focused on one section at a time. Other sections remain cool, heat less, or are remediated less.

The focal points of the various beams may be formed at other locations, such as at a different point or along a line. Different arrays or different beams from the same arrays may be directed to different portions of the plug in an interleaved or simultaneous manner. A channel or larger region may be remediated at a same time.

In one embodiment, the ultrasound remediation is combined with other remediation. For example, a warming blanket or other source of external heat is applied to the unpressured end of the plug. The plug is melted by this external heat. When only a certain amount, such as 1-2 feet of plug material completely blocking the pipe remains, ultrasound is used to open a channel. The ultrasound may be used to grow the channel to a larger diameter, such as up to the internal wall of the pipe. External heating may be used for further removing any remaining plug deposits at the wall of the pipe. As another example, ultrasound is used to open a channel. Once open, flow will begin. A chemical may be inserted into the pipe and flow to the remaining blockage. The chemical may assist or complete removal of the plug material.

In act 38, an aperture is opened in the obstruction. The acoustic energy causes an opening for form. In one embodiment, the acoustic energy causes heat. The heat melts the plug material. In other embodiments, the acoustic energy causes cavitations or bubble formation in the plug. This acts to destroy the structural integrity of the plug. In yet another approach, the acoustic energy causes displacement of plug materials by the passing acoustic waves. This vibration may weaken or remove plug material. Combinations of heat, cavitations, and/or displacement may be used.

One portion of the plug is remediated (e.g., heated) by the acoustic energy more than another portion. For example, the center is heated more than the parts adjacent to the pipe. The acoustic energy travels from different directions to constructively combine at the desired portion with less constructive combination adjacent to the pipeline. The plug is gently melted from the inside out in cross-section and/or in length along the pipe using conformal high intensity ultrasound.

As the acoustic energy propagates into the plug material, the acoustic waves may be absorbed and converted to heat. Absorption of sound by hydrate or plug material is much higher than steel or pipe material, allowing remediation of the plug material without heating the pipe as much.

As the plug is remediated, the blockage material progressively reincorporates into the flow stream. Once a channel is formed, the flow will increase, but without creating a ballistic object out of the plug. The opening may decrease the pressure, returning the pipeline to safer operation.

The transmission and directing acts 34, 36 are repeated. The repetition is performed to form a channel in the plug or remove the plug. The repetition may alternatively or additionally be performed to complete remediation at a given point. The scanning and detection may be repeated, such as repeating to monitor progress of the remediation. The characteristics of the beams, the locations, the pulse repetition frequency, and/or the duration may be altered based on imaging feedback. The focal region may be altered based on feedback. Alternatively, the beams and/or focus remain the same until the plug is no longer detected or a time limit is reached.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A method for high intensity ultrasound in pipeline obstruction remediation, the method comprising:
scanning the pipeline with ultrasound;
detecting the obstruction from the scanning;
transmitting, in response to the detecting, acoustic energy into the pipeline from a plurality of ultrasound transducers positioned around at least a portion of the pipeline; and
directing the transmitting of the acoustic energy to a portion of the obstruction away from walls of the pipeline.

2. The method of claim 1 wherein the ultrasound transducers each comprise an array of elements, wherein transmitting comprises transmitting from each of the arrays of elements, and wherein directing comprises causing a greater intensity of the acoustic energy at the portion than spaced away from the portion due to the acoustic energy from the different arrays constructively summing at the portion.

3. The method of claim 1 wherein directing comprises electronically focusing the acoustic energy at the portion.

4. The method of claim 1 wherein transmitting comprises transmitting the acoustic energy from outside the pipeline; and
further comprising:
opening an aperture in the obstruction from heat caused by the acoustic energy at the portion.

5. The method of claim 1 further comprising positioning the ultrasound transducers spaced around at least 150 degrees of the pipeline.

6. The method of claim 1 further comprising repeating the transmitting and the directing for other portions of the obstruction.

7. The method of claim 1 wherein scanning comprises scanning with different ultrasound transducers than used for the transmitting, the ultrasound transducers for transmitting and for scanning being interleaved around an outside of the pipeline.

8. The method of claim 1 wherein detecting comprises measuring a flow in the pipeline.

9. The method of claim 1 wherein detecting comprises identifying a morphology of the obstruction.

10. The method of claim 1 wherein detecting comprise detecting locations of the obstruction from the scanning, and wherein directing comprises directing as a function of the locations.

11. A system for high intensity ultrasound in pipeline obstruction remediation, the system comprising:
at least one ablation transducer operable to transmit high intensity focused ultrasound;
at least one detection transducer operable to transmit acoustic energy for imaging;
a transmit beamformer configured to transmit the high intensity focused ultrasound from the at least one ablation transducer; and
a processor operable to identify the pipeline obstruction with the detection transducer and to cause the transmit beamformer, with the at least one ablation transducer, to transmit the high intensity focused ultrasound from the at least one ablation transducer and at the obstruction.

12. The system of claim 11 wherein the at least one ablation transducer comprises a multidimensional array of elements, and wherein the transmit beamformer is operable to generate relatively delayed electrical signals for focusing the high intensity focused ultrasound at a portion of the pipeline obstruction spaced from walls of the pipeline.

13. The system of claim 11 wherein the at least one ablation transducer comprises a plurality of ablation transducers, and wherein the transmit beamformer is operable to transmit the high intensity focused ultrasound from the ablation transducers.

14. The system of claim 11 wherein the at least one ablation transducer and the at least one detection transducer comprises a cuff having a plurality of ablation transducers and a separate plurality of detection transducers, and wherein the processor and transmit beamformer are within the cuff.

15. The system of claim 11 wherein the at least one ablation transducer and the at least one detection transducer are a same transducer.

16. The system of claim 11 wherein the processor comprises a B-mode detector, a flow detector, or combinations thereof.

17. The system of claim 11 wherein the at least one ablation transducer comprises a transducer operable from outside of the pipeline.

18. The system of claim 11 wherein the processor is configured to determine an amount of remediation of the obstruction due to heating by the high intensity focused ultrasound.

19. A method for high intensity ultrasound in pipeline obstruction remediation, the method comprising:
transmitting acoustic energy from a plurality of locations outside of the pipeline, the locations spaced apart around part of a periphery of the pipeline; and
heating a portion of the obstruction with the acoustic energy more than heating of the obstruction adjacent to the pipeline with the acoustic energy, the acoustic energy traveling from different directions to constructively combine at the portion with less combination adjacent to the pipeline.

20. The method of claim 19 wherein transmitting comprises focusing the acoustic energy from each of a plurality of arrays, each of the locations being at each of the arrays, the focusing being at the portion.

21. The method of claim 19 further comprising detecting the obstruction with ultrasound from outside the pipeline, wherein the portion is identified from the detecting.
